(19) United States
(12) Patent Application Publication
(10) Pub. No.: US 2016/0002417 A1
(43) Pub. Date: Jan. 7, 2016

(54) TOUGHENED EPOXY RESIN/GLASS FIBER PREPREG AND PREPARATION METHOD THEREOF

(71) Applicant: CHANGZHOU LOONG TOP NEW MATERIALS TECHNOLOGY CO., LTD, Changzhou, Jiangsu (CN)

(72) Inventors: Haifeng BAO, Changzhou, Jiangsu (CN); Xiaoqiang CUI, Changzhou, Jiangsu (CN)

(73) Assignee: CHANGZHOU LOONG TOP NEW MATERIALS TECHNOLOGY CO., LTD, Changzhou (CN)

(21) Appl. No.: 14/812,004

(22) PCT Filed: Jun. 7, 2013
(86) PCT No.: PCT/CN2013/076922

§ 371 Date: Jul. 29, 2015

(30) Foreign Application Priority Data
Feb. 6, 2013 (CN) 201310048366.1

(51) Int. Cl. C08J 5/04; B32B 29/02; B32B 5/22; C08J 5/24; B32B 37/10

(52) U.S. Cl. CPC C08J 5/043; C08J 5/24; B32B 37/1018; B32B 5/22; B32B 29/02; C08J 2363/00; B32B 2255/26; B32B 2255/02; B32B 2262/101; B32B 2307/718; B32B 2309/68; B32B 2310/14; B32B 2307/558

(57) ABSTRACT

The present invention provides a toughened epoxy resin/glass fiber prepreg and a preparation method thereof. In a vacuum apparatus, a plasma-treated glass fiber cloth is impregnated with a toughened epoxy resin so as to form a prepreg with the reinforced fibers fully impregnated with the matrix resin, wherein the resin content is greater than or equal to 15% and less than or equal to 30%. A vacuum infusion process used in the present invention solves problem such as a complex preparation process, relatively high costs and difficult control of the resin content and the like in the current glass fiber prepregs. In addition, the toughened epoxy resin used in the prepreg comprises a mixed amine curing agent and a nano-toughening agent, which has a significant toughening effect, results in a resin casting body of excellent properties, and produces a composite material by curing a prepreg with a glass fiber woven cloth through impregnation under vacuum conditions, which has excellent impact resistance.

### FIELD

The present invention relates to the field of polymeric materials, specifically to a toughened epoxy/glass fiber prepreg and its preparation method.

### BACKGROUND

Epoxy/glass fiber composite material is one of the most widely used composite materials known for its low density (only a quarter of that of steel), high strength, big modulus, good corrosion resistance, and excellent electrical properties. In addition, the its raw materials are widely available, simple in molding and processing with high productivity and designability, which makes it an important composite widely used in the national economy and national defense.

Although epoxy resin is characterized with strong adhesiveness, good workability and small shrinkage, and has become one of the thermosetting resins most commonly used in the prepreg applications, epoxy resin not toughened is extremely brittle due to high crosslink density, and its fatigue strength and impact toughness often fail to meet the requirements for product performance. Epoxy toughening mechanism can be generally divided into two types: The first is rubber filling technique based on the “sea island structure”, which emphasizes homogeneity and dispersibility of the sea island structure and where the island and the resin are embedded in each other. The second is the use of polymer materials, typically liquid nitrile rubber, with focus on the binding capacity with the resin. It is worth noting that while these tougheners may significantly improve the toughness of epoxy resin, they reduce at some extent its flexural strength, tensile strength and heat resistance of the material, exposing many of its deficiencies.

Epoxy/glass fiber prepreg is used in one of the important methods of preparing the composite material. Two methods are available to produce prepgreg: solution impregnation and heat fusion. Both require complicated equipment and process, leading to high cost and the inability to control the resin content in the prepreg.

In addition, the glass fiber and glass fiber cloth have the advantages of high strength, dimensional stability, and high temperature and corrosion resistance, but also show obvious shortcomings, such as brittleness and low resistance to folding and wear, which seriously affect their service life. Surface treatment can enhance the folding and wear resistance of the glass fiber and glass fiber cloth, improve the wettability of the resin and prolong the life of glass fiber composite materials. At present, sizing agent is used for surface treatment of the glass fiber and glass fiber cloth, but the following problems need to be addressed: 1) Glass fibers, after treated with sizing agent, must be pre-baked and baked to dry the impregnation liquid to form a coating over the surface of the fiber. The process is complicated, time-consuming and requires a lot of energy; 2) The stability of the sizing agent in storage is yet to be improved, and phase splitting, which affects the quality of the sizing agent, often occurs during use; and 3) The size has a high level of coupling agent that is unstable and also affects the use of the sizing agent.

These problems often result in low resin content, poor mechanical strength of glass fiber composite products and high production costs.

The low-temperature plasma technology is an effective surface treatment method experiencing rapid development in recent years, and can be used to modify the surfaces of, for example, plastic, rubber, metal, ceramic and glass. It is characterized with its ability to initiate a series of chemical and physical reactions in the surface, including etching to roughen, surface cross-linking and the introduction of oxygen-containing polar groups, which significantly improve surface hydrophilicity and adhesion, while the characteristics of the matrix remain substantially unchanged.

### SUMMARY

One object of the present invention is to provide a kind of anti-shock, tough epoxy/glass fiber prepreg.

Another object of the present invention is to provide a preparation process of said toughened epoxy resin glass fiber prepreg, where resin-impregnated glass fiber woven cloth added with an appropriate ratio of toughening agent is applied, and the vacuum infusion process is used to prepare toughened epoxy resin/glass fiber prepreg.

According to one aspect of the present invention, a kind of toughened epoxy resin/glass fiber prepreg is provided, including glass fiber as reinforcing fiber, toughened epoxy resin as matrix resin, and release paper, wherein the said toughened epoxy resin/glass fiber prepreg prepared with enhanced fiber prepreg that is completely saturated with matrix resin after toughened epoxy resin impregnation through the use of the vacuum infusion process. The said toughened epoxy resin/glass fiber impregnated prepreg has a resin content greater than or equal to 15% and less than or equal to 30%, and its surface is covered with a layer of release paper.

The resin content of the toughened epoxy resin/glass fiber prepreg is preferably 20%.

In some embodiments, the said toughened epoxy resin is prepared using, by weight, 100 parts of bisphenol A epoxy resin (epoxy value 0.41-0.56), 20-40 parts of curing agent, and 0.10-1.5 parts of toughener.

As a preferred embodiment, the said curing agent is mixed amine hardener, a mixture of m-phenylenediamine and 4,4-diaminodiphenylmethane (DDM).

Preferably, the weight of the 4,4-diamino-diphenylmethane (DDM) is 15-75 wt % of the weight of m-phenylenediamine.

Preferably, the said toughener is dendrimer functionalized silica or titania submicron particle toughener.

Preferably, the dendrimer functionalized silica or titania submicron particle toughener is generated by reaction of dendrimer with silica or titania submicron particles. The said dendrimer is one with hydrolyzable alkoxysilicon ester groups in the center and multiple amino reactive groups as end groups that can be reacted with epoxy bisphenol A, for example, G_{6.0}-PAMAM-(NH₂)_{z}, where G _{6.0} refers to the sixth generation dendrimer, PAMAM means polyamide-amine dendrimer, and z is the number of terminal amino groups, where 1<z<128.

In said dendrimer functionalized silica or Mania submicron particle tougheners, the dendrimers are located in the surface of said silica or Mania submicron particles and combined by covalent bonds with silicon oxide or titanium oxide, where the said dendrimer content is 3 to 20 wt-% of that of the toughening agent.

In some embodiments, the said glass fiber is glass fiber woven cloth treated with plasma, and its mass per unit area is greater than or equal to 100 g/m² and less than or equal to 500 g/m².

In some embodiments, the plasma-treated glass fiber woven cloth is fabricated by the following process:

(1) Plasma surface treatment of glass fiber woven fabric at low temperature and atmospheric pressure.

Pre-dried glass fiber woven cloth of a certain weight is placed in the cavity of the plasma equipment. The high-pressure air flow meter is then switched on and the reducing valve is adjusted to allow the air flow to reach an appropriate value when the power supply is turned on to discharge and stabilize tom 10 to 30 minutes and then the output voltage of the power supply is slowly reduced and returned to zero. The power supply and the reducing, valve are shut down, and the treated glass fiber woven cloth is taken out for future use.

(2) Coupling agent dispersion liquid is sprayed on the glass fiber woven cloth.

(2a) Configuration of the coupling agent dispersion liquid.

0.5 to 1.0 parts by weight of vinyl triethoxysilane and 99.0 to 99.5 parts by weight of ethanol are accurately measured and put into the reaction kettle, where they are stirred and mixed for 10 to 15 minutes to get coupling agent dispersion liquid.

(2b) Spray of coupling agent dispersion liquid.

The coupling agent dispersion liquid formulated in Step (2a) is put into the sprinkling can and sprayed on the glass fiber woven cloth treated in Step (1), which is then placed in the ventilation at room temperature for 60 to 120 minutes, until the ethanol is evaporated to dryness.

(3) Secondary surface treatment of glass fiber woven cloth using plasma at low temperature and atmospheric pressure.

The glass fiber woven cloth prepared in Step (2b) is place in the cavity of the plasma equipment. The high-pressure air flow meter is then switched on and the reducing valve is adjusted to allow the air flow to reach an appropriate value when the power supply is turned on to discharge and stabilize for 10 to 30 minutes, and then the output voltage of the power supply is slowly reduced and returned to zero. The power supply and the reducing valve are shut down, and plasmas treated glass fiber woven cloth is obtained.

As a preferred embodiment, the glass fiber woven fabric in Step (1) above is treated in the cavity of the plasma equipment for 12 minutes.

As a preferred embodiment, the coupling agent dispersion liquid in Step (2a) above comprises the following components:

| | |
|---|---|
| Vinyl triethoxysilane | 0.8% |
| Anhydrous ethanol | 99.2%. |

As a preferred embodiment, the treated glass fiber woven cloth in Step (2b) above is placed in the ventilation at room temperature for 120 minutes, until the ethanol is evaporated to dryness.

As a preferred embodiment, the glass fiber woven cloth in Step (3) above is treated in the cavity of the plasma equipment for a second time for 5 minutes.

According to another aspect of the present invention, a toughened epoxy resin/glass fiber prepreg preparation method is provided, wherein the said toughened epoxy resin/glass fiber prepreg preparation method comprises the following steps, where the parts are counted by weight:

1. 15-75 parts of DDM and 100 parts of m-phenylenediamine are placed in a reaction kettle with stirring and heating means, where they got mixed at a temperature of 90-120° C. for more than 3 hours and then cooled to room temperature for the mixed amine curing agent, a liquid at room temperature;

2. 100 parts of a bisphenol A epoxy resin and 0.10-1.5 parts of toughener are mixed and placed in a container, and then heated to 60° C. under stirring and stirred for 15-60 minutes. 20-40 parts of the mixed amine curing agent obtained in Step 1 are added while the stirring continues at 60° C.; and

3. A winding machine is used to roll up the 100 parts by weight of glass fiber woven cloth and the double-sided release paper, which are placed in a vacuum bag with the temperature raised to 50-60° C. While the vacuum is pumped for, 18-43 parts by weight of the resin obtained in Step 2 are poured into the glass fiber woven cloth, until the latter is completely soaked and then cooled to room temperature. At this point, the said preparation of the prepreg is completed.

In line with the toughening mechanism in accordance with the “sea island structure”, the dendrimer functionalized nano-silica or titania submicron particles are used as to toughening agent, which not only bonds well with the epoxy resin and can be uniformly dispersed in the epoxy resin, but also forms an interpenetrating network structure that significantly improves the impact properties of the matrix resin.

The benefits of the present invention are:

1. The toughened epoxy resin/glass fiber prepreg involved in the present invention, after curing, results in a composite material with remarkable mechanical performance and the impact property substantially increased to more than 450 KJ/m².

2. The toughened epoxy resin/glass fiber prepreg involved in the present invention is fabricated using the vacuum infusion process that ensures full impregnation of glass fiber and epoxy resin and is characterized with simple production process, good reproducibility and low cost.

3. The toughened epoxy resin/glass fiber prepreg involved in the present invention is fabricated using. plasma treated glass fiber woven cloth, whose surface generates a large number of functional groups, which greatly enhance the binding capacity with the matrix resin.

4 The toughened epoxy resin glass fiber prepreg involved in the present invention is fabricated using epoxy-bisphenol A resin and mixed amine curing agent added with a certain proportion of toughener, resulting in greater toughness and excellent binding properties with glass fiber.

### DETAILED DESCRIPTION

The present invention, the toughened epoxy resin/glass fiber prepreg preparation method using vacuum infusion process, is further described below in conjunction with the embodiments.

### Embodiment 1

### Preparation of Glass Fiber Woven Cloth with Plasma Surface Treatment

Detailed steps are as follows:

### Step 1

### Plasma Surface Treatment of the Glass Fiber Woven Cloth at Low Temperature and Atmospheric Pressure

A roll of 5 kg of pre-dried glass fiber woven cloth is placed in the cavity of the plasma equipment. The high-pressure air flow meter is then switched on and the reducing valve is adjusted to allow the air flow to reach an appropriate value when the power supply is turned on to discharge and stabilize for 12 minutes, and then the output voltage of the power supply is slowly reduced and returned to zero. The power supply and the reducing valve are shut down, and the treated glass fiber woven cloth is taken out for future use.

### Step 2

### Spray of the Coupling Agent Dispersion Liquid

### Preparation of Coupling Agent Dispersion Liquid

0.8 parts by weight of vinyl triethoxysilane, the silane coupling agent, and 99.2 parts of anhydrous ethanol by weight are placed in the reaction kettle, where they are mixed and stirred for 10 minutes to obtain the coupling agent dispersion liquid.

### Spray of Coupling Agent Dispersion Liquid

200 ml of said coupling agent dispersion liquid is placed in the sprinkling can and uniformly sprayed onto the glass fiber woven cloth treated in Step 1, which is then placed in the ventilation at room temperature for 120 minutes, until the ethanol is evaporated to dryness.

### Step 3

### Secondary Plasma Surface Treatment of Glass Fiber Woven Cloth at Low Temperature and Atmospheric Pressure

The glass fiber woven cloth prepared in Step 2 is placed in the cavity of the plasma equipment. The high-pressure air flow meter is then switched on and the reducing valve is adjusted to allow the air flow to reach an appropriate value when the power supply is turned on to discharge and stabilize for 3 to 5 minutes, and then the output voltage of the power supply is slowly reduced and returned to zero. The power supply and the reducing valve are shut down, and the plasmas treated glass fiber woven cloth is obtained.

The glass fiber woven cloth processed and obtained as a result of the embodiment above complies with the technical indicators specified by national standard GB/T18371-2008.

### Embodiment 2

### Preparation of Dendrimer Functionalized Titania Submicron Particle Toughener

Detailed steps are as follows:

The terminal amino group of the dendrimer G_{6.0}-PAMAM-(NH₂ )_{z} (produced by Changchun Institute of Applied Chemistry) and the titania micron particles are dispersed in acetone (or other organic solvents, such as anhydrous ethanol, n-hexane, cyclohexane, toluene, etc.) and added into the reaction kettle equipped with a stirring and heating apparatus. The titania-micron particles used here are uniformed ones obtained through the hydrolysis treatment of organic titanate particles, prepared by the widely applied industrial method, where the n-butyl titanate is hydrolyzed under acidic conditions. The titanium oxide micron particles thus obtained have narrowly distributed sizes, which can be made between 0.5 to 3.0 microns by controlling the reaction conditions, The amount of the titanium dioxide micron particles added is 20-97 wt % of the total amount of the toughener. The dendrimers used have hydrolyzable alkoxysilicon ester groups in the center and multiple amino groups at the terminals. The temperature in the reaction kettle is raised to 78° C., and the content is stirred and mixed at this temperature for more than 60 minutes before suction filtered, washed three times with an organic solvent and dried to obtain the functionalized dendrimer titania micron particle toughener.

### Embodiment 3

### Preparation of Dendrimer Functionalized Silica Submicron Particle Toughener

Detailed steps are as follows:

0.5˜3 g of dendrimer G _{6.0}-PAMAM-(NH₂)_{z} (produced by Changchun Institute of Applied Chemistry) is dispersed in 50 to 150 ml of the acetone (or other organic solvents, such as anhydrous ethanol, n-hexane, cyclohexane, toluene, etc,), and then 8˜12 g of nano-silica is dispersed in 50 to 150 ml of the acetone. The liquid is added to the reaction kettle stirring and heating means. The temperature of the kettle is raised to 78° C. and the content is stirred and mixed for more than 60 minutes before is suction filtered, washed with acetone for three times and dried to get the dendrimer functionalized silica submicron particle toughener. Dendrimer G_{6.0}-PAMAM-(NH₂)_{z} has hydrolyzable alkoxysilicon ester groups in the center and a plurality of amino-reactive groups at the terminals, and can be reacted with bisphenol A with ethylene dendrimer. The said nano-silica is unitbrmly sized particles, with particle size between 100 to 800 nanometers, obtained from hydrolysis treatment of silicone ester.

### Embodiment 4

### Preparation of Toughened Epoxy Resin/Glass Fiber Prepreg

Detailed steps are:

Step 1: 43 parts of DDM, and 100 parts of m-phenylenediamine are added to the reaction kettle with stirring and heating means and mixed at 120° C. for 3 hours and then cooled to room temperature to obtain the mixed amine curing agent, a liquid at room temperature.

Step 2: 100 parts of bisphenol A epoxy resin and 0.20 parts of the dendrimer functionalized titanium dioxide toughener obtained in Embodiment 2 are mixed in the vessel and heated to 60° C. under stirring. The mixture is stirred for 60 minutes and then added 24 parts of the mixed amine curing agent obtained in the first step. The stirring is continued and the temperature is maintained at 60° C.

Step 3: A winding machine is used to roll up the 100 parts by weight of the plasma treated glass fiber woven fabric and the double-sided release paper prepared in Embodiment 1, which are placed in the vacuum bag and heated to 60° C. At the vacuum state, 2.5 parts of the resin obtained in the second step is poured into the glass fiber woven cloth, until it is completely soaked and then cooled to room temperature. Thus, the preparation of a prepreg is completed.

### Embodiment 5

### Preparation of Toughened Epoxy Resin/Glass Fiber Prepreg

Detailed steps are:

Step 1: 35 parts of DDM and 100 parts of m-phenylenediamine are added to the reaction kettle with stirring and heating means, mixed for 5 hours at 100° C. and then cooled to room temperature to obtain the mixed amine curing agent, a liquid at room temperature.

Step 2: 100 parts of bisphenol A epoxy resin and 0.10 pans of dendrimer functionalized silica toughener are mixed in the vessel, and then heated to 60 ° C. under stirring. The mixture is stirred for 60 minutes and then added 20 parts of the mixed amine curing agent obtained in the first step. The stirring is continued and the temperature is maintained at 60° C.

Step 3: A winding machine is used to roll up the 100 parts by weight of the plasma treated glass fiber woven fabric and the double-sided release paper prepared in Embodiment 1, which are placed in the vacuum bag and heated to 60° C. At the vacuum state, 20 parts of the resin obtained in the second step is poured into the glass fiber woven cloth, until it is completely soaked and then cooled to room temperature. Thus, the preparation of a prepreg is completed.

### Embodiment 6

### Preparation of Toughened Epoxy Resin/Glass Fiber Prepreg

Detailed steps are:

Step 1: 30 parts of DDM, and 100 parts of m-phenylenediamine are added to the reaction kettle with stirring and heating means, mixed for 2 hours at 120° C. and then cooled to room temperature to obtain the mixed amine curing agent, a liquid at room temperature.

Step 2: 100 parts of bisphenol A epoxy resin and 0.20 parts of the dendrimer functionalized titanium dioxide toughener obtained in Embodiment 2 are mixed in the vessel and heated to 60° C. under stirring. The mixture is stirred for 60 minutes and then added 24 pans of the mixed amine curing agent obtained in the first step. The stirring is continued and the temperature is maintained at 60° C.

Step 3: A winding machine is used to roll up the 100 parts by weight of the plasma treated glass fiber woven fabric and the double-sided release paper prepared in Embodiment 1, which are placed in the vacuum bag and heated to 60° C. At the vacuum state, 20 parts of the resin obtained in the second step is poured into the glass fiber woven cloth, until it is completely soaked and then cooled to room temperature. Thus, the preparation of a prepreg is completed.

The toughened epoxy resin/glass fiber prepreg obtained in the above-described embodiments is cured at 120° C. for about 15 hours, cooled to room temperature and then taken out to be cut into samples 80*10*4 mm for the impact strength test. The test results are shown in the following table:

### Data Sheet of the Impact Strength Test on Toughened Epoxy Resin/Glass Fiber Composite

| Embodiment | Impact Strength (kJ/m²⁾ | | | |
|---|---|---|---|---|
| No. | 1 | 2 | 3 | Average |
| 4 | 451.85 | 448.25 | 455.15 | 451.75 |
| 5 | 372.05 | 370.35 | 371.75 | 371.38 |
| 6 | 402.30 | 399.75 | 405.15 | 402.40 |

As can be seen from the Table, the toughened epoxy glass fiber prepreg obtained from each of the embodiment, after curing, forms a composite material that has a high practical value.

What is claimed is:

1. A toughened epoxy resin glass fiber prepreg, comprising glass fiber as reinforcing fiber, toughened epoxy resin as a matrix resin and release paper, wherein,
the toughened epoxy resin/glass fiber prepreg is prepared with enhanced fiber prepreg that is completely saturated with matrix resin after toughened epoxy resin impregnation through the use of the vacuum infusion process, and the toughened epoxy resin/glass fiber impregnated prepreg has a resin content greater than or equal to 15% and less than or equal to 30%, and its surface is covered with a layer of release paper.

2. The toughened epoxy resin/glass fiber prepreg according to claim 1, wherein, the glass fiber is plasma treated glass fiber woven cloth, whose mass per unit area is equal to or greater than 100 g/m² and equal to or less than 500 g/m².

3. The toughened epoxy resin/glass fiber prepreg according to claim 1, wherein,
the toughened epoxy resin is made from 100 parts of bisphenol A epoxy resin, 20-40 parts of curing agent and 0.10-1.5 parts of toughener by weight,
the bisphenol A epoxy resin has an epoxy value of 0.41-0.56 and the curing agent is a mixed amine curing agent of p-phenylenediamine and 4,4-diaminodiphenylmethane, the weight of 4,4-diaminodiphenylmethane is weight of 15-to 75 wt % of that of m-phenylenediamine, and the toughener is silica functionalized dendrimer or titania submicron particles.

4. The toughened epoxy resin/glass fiber prepreg according to claim 1, wherein,
the dendrimer functionalized silica or titania submicron particle toughener is generated by reaction of dendrimers with silicon oxide or titanium oxide submicron particles, in which the dendrimer has hydrolyzable alkosysilicon ester groups in the center and a plurality of amino reactive groups at the terminals, and can be reacted with epoxy bisphenol A, and the dendrimer is distributed on the surface of the silica or titania submicron particles and combined with silica or titania via covalent bonds, in which the content of the dendrimers is 3-20 wt % of that of the toughening agent.

5. The toughened epoxy resin/glass fiber prepreg according to claim 4, wherein,
the dendrimer is G_{6.0}-PAMAM-(NH₂)_{z} in which G_{6.0} refers to the sixth generation dendrimer. PAMAM means polyamide-amine dendrimer and z is the number of amino groups, where 1<z<128.

6. A preparation method for the toughened epoxy resin/glass fiber prepreg according to claim 1, wherein, the method comprises the following steps, in which the parts are counted by weight:
1) 15-75 parts of 4,4-diaminodiphenylmethane and 100 parts of m-phenyleriediamine are added to the reaction kettle with stirring and heating means, where they are mixed for more than 3 hours in a temperature of 90-120° C. and then cooled to room temperature to obtain the mixed amine curing agent, a liquid at room temperature;
2) 100 parts of bisphenol A epoxy resin and 0.10-1.5 parts of toughener are mixed and placed in a container, and then heated to 60° C. under stirring and stirred for 15-60 minutes, 20-40 parts of the mixed amine curing agent obtained in Step 1 is added while the stirring continues at 60° C.; and
3) winding machine is used to roll up the 100 parts of glass fiber woven cloth and the double-sided release paper, which are placed in a vacuum hag with the temperature raised to 50-60° C., while vacuum pumping, 18-43 parts of the resin obtained in Step 2 is poured into the glass fiber woven cloth, until the latter is completely soaked and then cooled to room temperature, at this point, the preparation of the prepreg is completed.

7. The preparation method according to claim 6, wherein,
The glass fibers are plasma treated glass fiber woven fabric, whose mass per unit area is greater than or equal to 100 g/m² and equal to or less than 500 g/m².

8. The preparation method according to claim 6, wherein,
the toughened epoxy resin is made from 100 parts of bisphenol A epoxy resin, 20-40 parts of curing agent and 0.10-1.5 parts of toughening agent by weight, where the bisphenol A epoxy resin has an epoxy value of 0.41-0.56, and the curing agent is mixed amine curing agent, which is a mixture of m-phenylenediamine and 4,4-diaminodiphenylmethane, where the 4,4-diaminodiphenylmethane weighs 15-75 wt % of m-phenylenediamine, and the toughener is dendrimer functionalized silica or titania submicron particles toughener.

9. The preparation method according to claim 6, wherein,
the dendrimer functionalized silica or titania submicron particle toughener is generated by reaction of dendrimers with silicon oxide or titanium oxide submicron particles, in which the dendrimer has hydrolyzable alkoxysilicon ester groups in the center and a plurality of amino reactive groups at the terminals, and can be reacted with epoxy bisphenol A, and the dendrimer distributed on the surface of the silica or titania submicron panicles and combined with silica or titania via covalent bonds, in which the content of the dendrimers is 3-20 wt % of that of the toughening agent.

10. The preparation method according to claim 9, wherein, the dendrimer is G_{6.0}-PAMAM-(NH₂)_{z}, in which G_{6.0} refers to the sixth generation dendrimer, PAMAM means polyamide-amine dendrimer and z is the number of amino groups, where 1<z<128.
